(19) United States
(12) Patent Application Publication
(10) Pub. No.: US 2010/0253202 A1
(43) Pub. Date: Oct. 7, 2010

(54) Ignition Coil for Vehicle

(75) Inventors: Harry Oliver Levers, JR., El Paso, TX (US); Albert Anthony Skinner, El Paso, TX (US)

Correspondence Address: DELPHI TECHNOLOGIES, INC, M/C 480-410-202, PO BOX 5052, TROY, MI, 48007, US

(73) Assignee: Delphi Technologies, Inc., Troy, MI (US)

(21) Appl. No.: 12/419,081

(22) Filed: Apr. 6, 2009

(51) Int. Cl. F02M 57/06

(52) U.S. Cl. 313/118

(57) ABSTRACT

A spark plug coil assembly has a primary core bearing primary windings and a secondary winding spool around which secondary windings are wound and in which the primary core is received. A case receives the spool with core. The entire case can be made of composite Iron to function as a magnetic return path for the core. Thick ends of the case support the ends of the core.

### FIELD OF THE INVENTION

The present invention relates generally to vehicle ignition coils.

### BACKGROUND OF THE INVENTION

Ignition coils are components that use the coupling between a primary winding and a secondary winding to transform relatively low voltages from the battery into high voltages that are supplied to the spark plugs in vehicle gasoline engines. The spark plugs start the internal combustion process that drives the rods and hence, crankshaft and axles. In older systems, a single ignition coil is provided, and a distributor sends the pulses from the coil through respective high voltage spark plug wires to the spark plugs in the cylinders in accordance with a timing that is established by the distributor.

In relatively modem engines, an engine can have several ignition coils, one for each cylinder or for each pair of cylinders, thereby advantageously eliminating the need for distributors and high voltage wires and also providing more precise control of the engine timing. One example of such an ignition coil system is set forth in U.S. Pat. No. 6,556,118, owned by the present assignee and incorporated herein by reference.

To provide a magnetic return path to the primary core around which the primary windings are wound, steel shields have been provided that surround the inside or outside of the case which holds the core. The primary core typically is centrally disposed in a secondary winding spool around which the secondary windings are wound, and the case holds the primary/secondary assembly. Such a shield, which also serves to direct flux to a main air gap that is associated with pole pieces, is described in U.S. Pat. No. 5,015,982, incorporated herein by reference.

### SUMMARY OF THE INVENTION

As understood herein, were a case holding the spool with core to be made of composite Iron and thereby obviate the need for the above-mentioned steel shield, which tends to crack because of its low coefficient of thermal expansion and which can entail additional cost and complexity attendant thereto, such a case might require an integral primary core and pole to direct the flux to the top of the case wall. Such a design might also require sealing at the bottom relative to the potting orientation.

A spark plug coil assembly includes a primary core bearing primary windings and a secondary winding spool around which secondary windings are wound. The primary core is received in the spool. A case receives the spool with core. The case is made of composite Iron to function as a magnetic return path for the core. The case defines a generally parallelepiped-shaped periphery and is configured to eliminate need for a separate pole piece and a shield such that no magnetic shield is provided on an inside or outside surface of the case.

The case can be electrically grounded. In some embodiments the case is formed with opposed first walls which are orthogonal to a longitudinal axis defined by the core and opposed second walls connecting the first walls. The first walls are thicker than the second walls to promote transfer of flux from the core to the case. Also, if desired the first walls can define a thickness of between about five to seven millimeters, inclusive. Respective mounting brackets may extend from the first walls and may be integral therewith.

In example embodiments the first walls are centrally formed on their inside surfaces with respective slots closely receiving respective ends of the core. Each slot may have a respective curved bottom surface on which the core rests. The entire case can be 40%-70% by volume Iron particles injection molded into a thermoplastic carrier.

In another aspect, a holding member for a secondary spool with primary core disposed centrally therein includes a composite Iron case formed with slots supporting respective ends of the core and configured to function as pole pieces for the core.

In another aspect, a method includes providing a primary core bearing primary windings and a secondary winding spool around which secondary windings are wound. The primary core is received in the spool. The method includes supporting opposite ends of the core using a case made of composite Iron to provide a magnetic flux return path for the core.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic block diagram of the coil in an intended environment;

FIG. 2 is a perspective view of the case;

FIG. 3 is a perspective view of the case with core; and

FIG. 4 is a perspective view of the case with core and spool.

### DETAILED DESCRIPTION OF THE PREFERRED EMBODIMENT

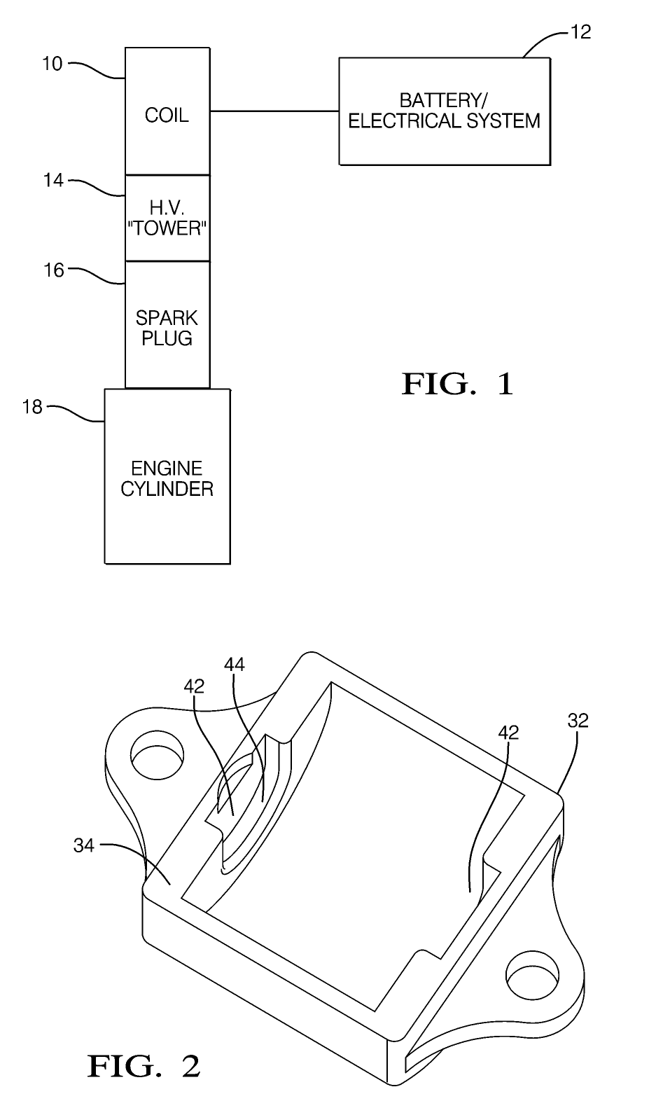

Referring initially to FIG. 1, a spark plug coil assembly is shown, generally designated 10, which can receive electrical power from a battery/electrical distribution system 12 of a vehicle and which can be coupled through a so-called “high voltage tower” 14 to one or more spark plugs 16, to provide combustion spark inside an engine cylinder 18. The HV tower 14 may include, without limitation, a cup and spring arrangement.

Cross-referencing FIGS. 2-4, details of an example embodiment of the coil assembly 10 can be seen, it being understood that various elements such as circuit boards, etc. which typically are included in coil assemblies are omitted for clarity. The assembly 10 includes an electrically insulated hollow secondary winding spool 20 (FIG. 4) that may be formed with plural radial ring-shaped ribs 22 for segment winding of a secondary coil around the spool 20. In other embodiments the secondary coil may be progressively wound on the spool 20. In any case, it is to be understood that the spool 20 may be formed with one or more secondary winding terminals that can be electrically connected to the HV tower 14 shown in FIG. 1.

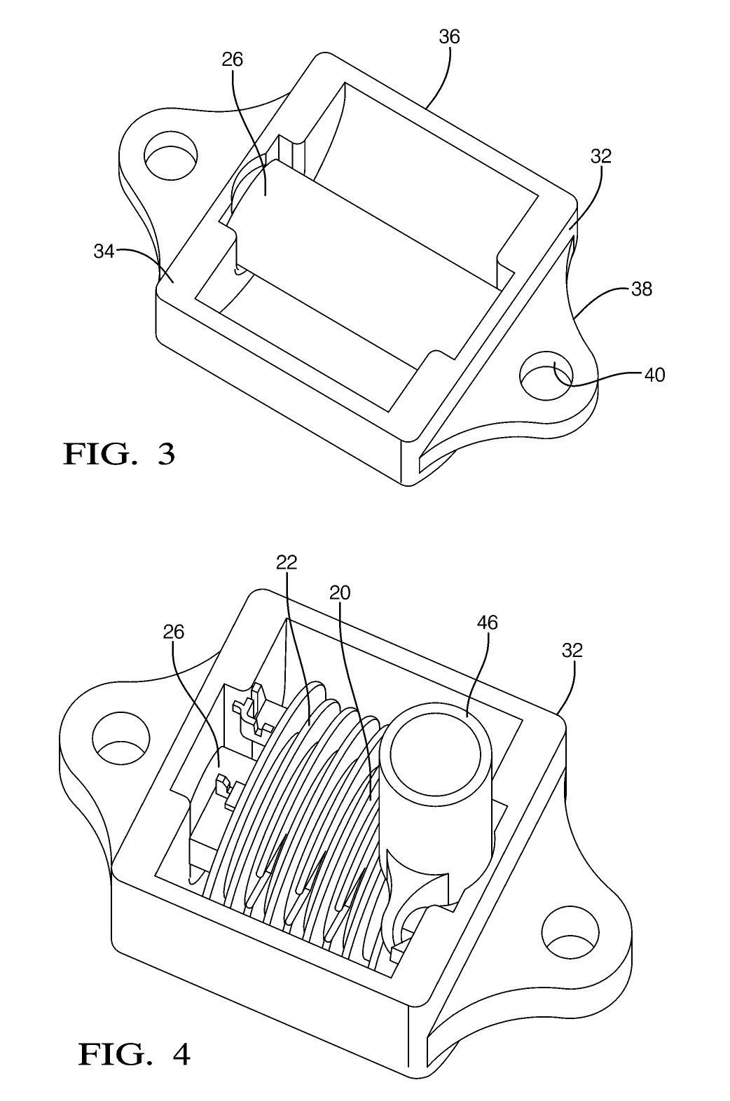

As shown in FIG. 4, the secondary winding spool 20 coaxially receives a primary core 26 around which a primary winding is wound. The primary winding receives electrical power from the distribution system 12 shown in FIG. 1. The primary core 26 can be made of compression molded composite Iron or laminated Iron. As shown in FIGS. 3 and 4, the core 26 has no integral pole piece; instead, it is cylindrical throughout its length.

A hollow case 32 that may have a generally parallelepiped-shaped periphery centrally holds the spool 20 with primary core 26. The case 32 may be made in some examples of composite Iron and more particularly may be 40%-70% by volume Iron particles injection molded into a thermoplastic carrier/fiberglass. As understood herein, by making the case 32 of composite Iron, the need for a second pole piece and a shield are eliminated, meaning that no magnetic shield is provided on the inside or outside surface of the case 32. Accordingly, the case 32 itself preferably is electrically grounded.

The example case 32 shown in FIGS. 2-4 is formed with opposed first walls 34 which are orthogonal to the longitudinal axis of the core 26. Connecting the first walls are opposed second walls 36, and the first walls may be thicker than the second walls as shown to promote transfer of flux from the core 26 to the case 32, i.e., to essentially function as pole pieces for the core 26. The thickness of the first walls 34 may be, e.g., five to seven millimeters (5 mm-7 mm). Integral mounting brackets 38 with respective mount holes 40 may extend from the first walls 34 as shown to mount the assembly 10.

As perhaps best shown in FIG. 2, the first walls 34 are centrally formed on their inside surfaces with respective slots 42. The slots 42 closely receive respective ends of the core 26 to tightly magnetically couple the core 26 to the walls 34. Each slot 42 can have a respective curved bottom surface 44 on which the cylindrical core 26 rests. In some embodiments the core is press fit into the slots 42.

FIG. 4 shows that a portion 46 of the high voltage tower described above can extend away from a potting surface of the assembly 10 and can contain structure to electrically connect the secondary windings to the spark plug.

The connector to the primary windings may exit the potting surface or may be configured as a “tongue and groove” connector through a wall of the case 32.

While the particular IGNITION COIL FOR VEHICLE is herein shown and described in detail, it is to be understood that the subject matter which is encompassed by the present invention is limited only by the claims.

What is claimed is:

1. Spark plug coil assembly comprising:
a primary core bearing primary windings;
a secondary winding spool around which secondary windings are wound, the primary core being received in the spool; and
a case receiving the spool with core, the case being made of composite Iron to function as a magnetic return path for the core, the case defining a generally parallelepiped-shaped periphery, the case being configured to eliminate need for a separate pole piece and a shield such that no magnetic shield is provided on an inside or outside surface of the case.

2. The assembly of claim 1, wherein the case is electrically grounded.

3. The assembly of claim 1, wherein the case is formed with opposed first walls which are orthogonal to a longitudinal axis defined by the core and opposed second walls connecting the first walls, the first walls being thicker than the second walls to promote transfer of flux from the core to the case.

4. The assembly of claim 3, wherein the first walls define a thickness of between about five to seven millimeters, inclusive.

5. The assembly of claim 3, comprising respective mounting brackets extending from the first walls and integral therewith.

6. The assembly of claim 3, wherein the first walls are centrally formed on their inside surfaces with respective slots closely receiving respective ends of the core.

7. The assembly of claim 6, wherein each slot has a respective curved bottom surface on which the core rests.

8. The assembly of claim 1, wherein the entire case is 40%-70% by volume Iron particles injection molded into a thermoplastic carrier.

9. Holding member for a secondary spool with primary core disposed centrally therein, comprising:
a composite Iron case formed with slots supporting respective ends of the core and configured to function as pole pieces for the core.

10. The holding member of claim 9, wherein the case defines a generally parallelepiped-shaped periphery, the case being configured to eliminate need for a separate pole piece and a shield such that no magnetic shield is provided on an inside or outside surface of the case.

11. The holding member of claim 9, wherein the case is electrically grounded.

12. The holding member of claim 9, wherein the case is formed with opposed first walls which are orthogonal to a longitudinal axis defined by the core and opposed second walls connecting the first walls, the first walls being thicker than the second walls.

13. The holding member of claim 12, wherein the first walls define a thickness of between about five to seven millimeters, inclusive.

14. The holding member of claim 12, comprising respective mounting brackets extending from the first walls and integral therewith.

15. The holding member of claim 12, wherein the first walls are centrally formed on their inside surfaces with the slots.

16. The holding member of claim 15, wherein each slot has a respective curved bottom surface on which the core rests.

17. The holding member of claim 9, wherein the entire case is 40%-70% by volume Iron particles injection molded into a thermoplastic carrier.

18. Method comprising:
providing a primary core bearing primary windings and a secondary winding spool around which secondary windings are wound, the primary core being received in the spool; and
supporting opposite ends of the core using a case made of composite Iron to provide a magnetic flux return path for the core.

19. The method of claim 18, comprising forming slots in the case to receive the ends.

20. The method of claim 19, wherein the slots are formed in first walls connected together by second walls thinner than the first walls.
